(19) United States
(12) Patent Application Publication
(10) Pub. No.: US 2013/0167720 A1
(43) Pub. Date: Jul. 4, 2013

(54) GAS PURIFICATION METHOD

(71) Applicants: Takayoshi Adachi, Tokyo (JP); Sachie Hashimoto, Tokyo (JP)

(72) Inventors: Takayoshi Adachi, Tokyo (JP); Sachie Hashimoto, Tokyo (JP)

(73) Assignee: TAIYO NIPPON SANSO CORPORATION, Tokyo (JP)

(21) Appl. No.: 13/822,388

(22) PCT Filed: Mar. 21, 2012
(86) PCT No.: PCT/JP2012/057088

§ 371 Date: Mar. 12, 2013

(30) Foreign Application Priority Data
Mar. 31, 2011 (JP) 2011-077041

(51) Int. Cl. B01D 53/04

(52) U.S. Cl. CPC B01D 53/0462
USPC 95/126; 95/139

(57) ABSTRACT

Provided is a gas purification method in which the amount of adsorbent is reduced, an adsorption column can be considerably miniaturized, the amount of regeneration gas can be reduced and the running cost can be reduced in cases where carbon dioxide or water which is an impurity contained in a gas to be purified is adsorptively removed; and in which a gas to be purified which contains carbon dioxide having a partial pressure of 35 Pa or lower as impurities is brought into contact with an adsorbent whose heat-regeneration temperature is set to from 160° C. to 240° C. composed of a faujasite type zeolite whose cation is sodium to adsorptively remove the carbon dioxide. Also provided is a gas purification method in which a gas to be purified is brought into contact with an adsorbent which is subjected to an initial activation at 300° C. or higher and composed of a faujasite type zeolite whose cation is lithium to adsorptively remove the residual carbon dioxide and a heat-regeneration is performed at 240° C. or lower.

### TECHNICAL FIELD

The present invention relates to a gas purification method, and more particularly to a gas purification method for adsorptively removing carbon dioxide contained in a gas to be purified.

### BACKGROUND ART

The purity requirement for oxygen gas, argon gas, helium gas, hydrogen gas, nitrogen gas used in a semiconductor manufacturing process is high. Since these gases contains impurities such as carbon dioxide, water, carbon monoxide and/or methane although the amount thereof is small, the impurities need to be removed.

In particular, in the case of purification of oxygen gas, as a method of removing impurities such as carbon monoxide, methane, hydrogen, water and carbon dioxide, a method is well-known in which a precious metal catalyst such as platinum group metals and oxygen gas containing impurities are brought into contact with under high temperature; carbon monoxide, methane and hydrogen are reacted with base oxygen to be subjected to a catalytic oxidation in which they are converted into carbon dioxide and water; and carbon dioxide and water contained in the oxygen gas which has been subjected to catalytic oxidation are removed by an adsorbent in the latter adsorption column.

As the adsorbent which adsorptively removes carbon dioxide and water contained in oxygen gas, at least one adsorbent selected from those having zinc oxide as a main ingredient and synthetic zeolite equivalent to molecular sieve 4A or 5A is known (see, for example, Patent Document 1).

### PRIOR ART REFERENCE

### Patent Document

Patent Document 1: JP-A 11-199206

### SUMMARY OF THE INVENTION

### Problems to be Solved by the Invention

During the purification of oxygen gas, carbon dioxide and water which are impurities are generally adsorptively removed by a twin-column type temperature swing adsorption (TSA) apparatus. In the twin-column type TSA apparatus, while an adsorption process (purification process) is performed in one adsorption column, a regeneration process is performed in another adsorption column by a heating gas. By switching these processes alternately, continuous purification of a gas can be attained.

However, since an A-type zeolite such as a molecular sieve 4A or 5A has a small pore volume and a small amount of adsorption, a large amount of adsorbent needs to be used for removing carbon dioxide or water. For this reason, the adsorption column needs to be increased, and a large amount of a regeneration gas at high temperature has been used to heat and cool a large adsorption column within a switching time. Since a part of purified oxygen gas is used for the regeneration gas, the running cost is thus increased, which has been problematic.

Accordingly, an object of the present invention is to provide a gas purification method in which an adsorption column can be considerably miniaturized in cases where carbon dioxide which is an impurity contained in a gas to be purified is adsorptively removed.

### Means for Solving the Problem

In order to attain the above-mentioned object, the gas purification method of the present invention is characterized in that a gas to be purified which contains carbon dioxide having a partial pressure of 35 Pa or lower as impurities is brought into contact with an adsorbent whose heat-regeneration temperature is set to from 160° C. to 240° C. composed of a faujasite type zeolite whose cation is sodium to adsorptively remove the carbon dioxide. Further, suitably, the faujasite type zeolite whose cation is sodium is exposed to the air or a gas containing water, and then is subjected to heat-regeneration to adsorptively remove the carbon dioxide.

Further, the gas purification method of the present invention is a gas purification method in which a gas to be purified which contains carbon dioxide as an impurity is brought into contact with an adsorbent composed of a faujasite type zeolite whose cation is lithium to adsorptively remove the carbon dioxide, characterized in that the faujasite type zeolite whose cation is lithium is subjected to an initial activation at 300° C. or higher, and subjected to heat-regeneration at 240° C. or lower in a subsequent regeneration process to adsorptively remove carbon dioxide repeatedly.

Further, the gas purification method of the present invention is characterized in that: a gas to be purified which contains carbon dioxide and water as impurities is brought into contact with an adsorbent composed of a faujasite type zeolite whose cation is sodium to adsorptively remove a part of carbon dioxide and water; and in the downstream thereof, the gas is brought into contact with an adsorbent which is subjected to an initial activation at 300° C. or higher and composed of a faujasite type zeolite whose cation is lithium to adsorptively remove the residual carbon dioxide, wherein the regeneration temperature of both adsorbents is from 160° C. to 240° C. Further, suitably, water in a gas to be purified is adsorptively removed to the content thereof of 1 ppb or lower by the adsorbent composed of a faujasite type zeolite whose cation is sodium, as well as, a part of carbon dioxide is adsorptively removed at a site where water is not adsorbed.

### Advantages of the Invention

In the gas purification method of the present invention, by using a faujasite type zeolite whose cation is sodium as an adsorbent and by setting the regeneration temperature to from 160° C. to 240° C., carbon dioxide at a partial pressure of 35 Pa or lower can be adsorptively removed effectively and the amount of the adsorbent can be reduced to obtain an adsorption column smaller than a conventional one. Note that, as the initial activated treatment of the faujasite type zeolite whose cation is sodium, a method of exposing to the air or a gas containing water is effective.

By the gas purification method of the present invention, a faujasite type zeolite whose cation is lithium is used as an adsorbent; is subjected to an initial activation at 300° C. or higher; carbon dioxide can be adsorptively removed effectively to thereby obtain an adsorption column smaller than a conventional one.

Since this lithium-type zeolite dramatically reduces its ability to adsorb carbon dioxide once it adsorbs water, by filling a sodium-type zeolite at the upstream side of the adsorption column to remove water (1 ppb or less) and to remove a part of carbon dioxide at a site where water is not adsorbed and by filling a lithium-type zeolite at the downstream side of the adsorption column to remove the residual carbon dioxide, purification of a gas containing carbon dioxide and water can be performed controlling the regeneration temperature from 160° C. to 240° C. and the running cost can be reduced.

### BRIEF DESCRIPTION OF THE DRAWINGS

FIG. 1 is a graph illustrating a carbon dioxide adsorption isotherm of a faujasite type zeolite whose cation is sodium at 25° C.

FIG. 2 is a graph illustrating the relationship between carbon dioxide adsorption of a faujasite type zeolite whose cation is sodium and the regeneration temperature at a carbon dioxide pressure of 18 Pa. FIG. 3 is a graph illustrating the relationship between carbon dioxide adsorption of a faujasite type zeolite whose cation is lithium and the regeneration temperature at a carbon dioxide pressure of 18 Pa. FIG. 4 is a graph illustrating the relationship between each adsorbent and the amount of dynamic adsorption of carbon dioxide in nitrogen gas and oxygen gas.

### MODES FOR CARRYING OUT THE INVENTION

The present embodiments will be described based on a purification of oxygen gas used for a semiconductor manufacturing process. In order to stably provide a high purity purified oxygen gas continuously, a twin-column type TSA apparatus provided with a pair of adsorption columns filled with adsorbent is used. Since a source oxygen gas before purification contains a trace amount of impurities such as carbon dioxide, water, carbon monoxide, methane and/or hydrogen, the gas is introduced into a reaction column filled with precious metal catalyst under high temperature before the gas is introduced into an adsorption column, and impurities such as carbon monoxide, methane and hydrogen are reacted with a base oxygen to be converted into carbon dioxide and/or water. By way of the reaction column, the gas to be purified is introduced into one adsorption column and carbon dioxide and/or water are adsorbed. At that time, the other adsorption column is heated and the adsorbent is regenerated, whereby a part of purified oxygen gas is used as a regeneration gas. The adsorption process and the regeneration process in both the adsorption columns are switched alternately to purify the gas continuously.

### Example 1

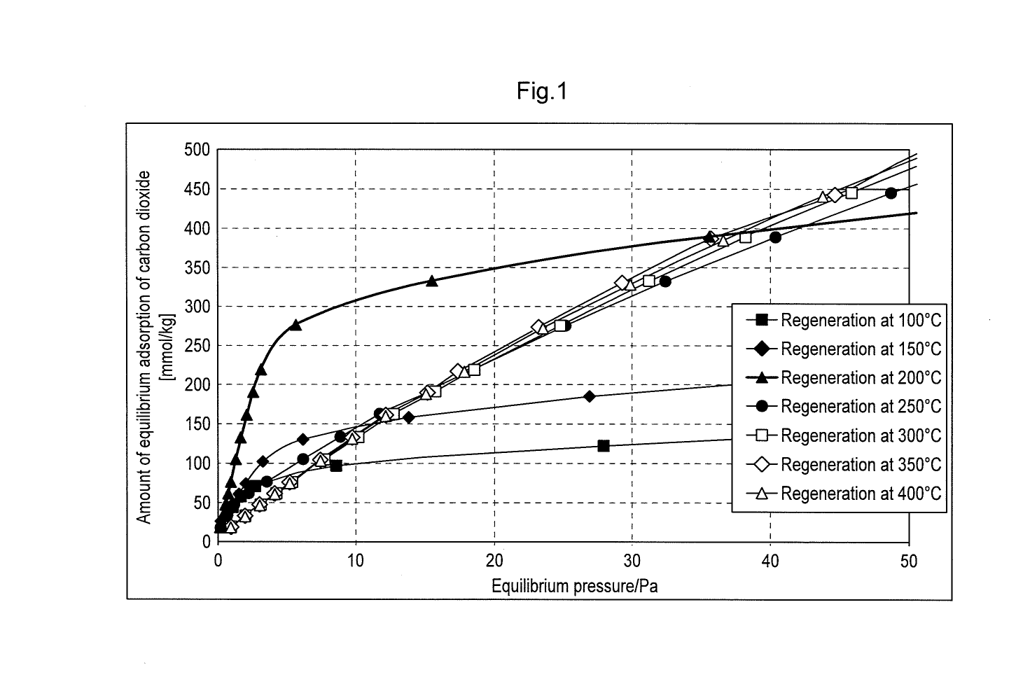

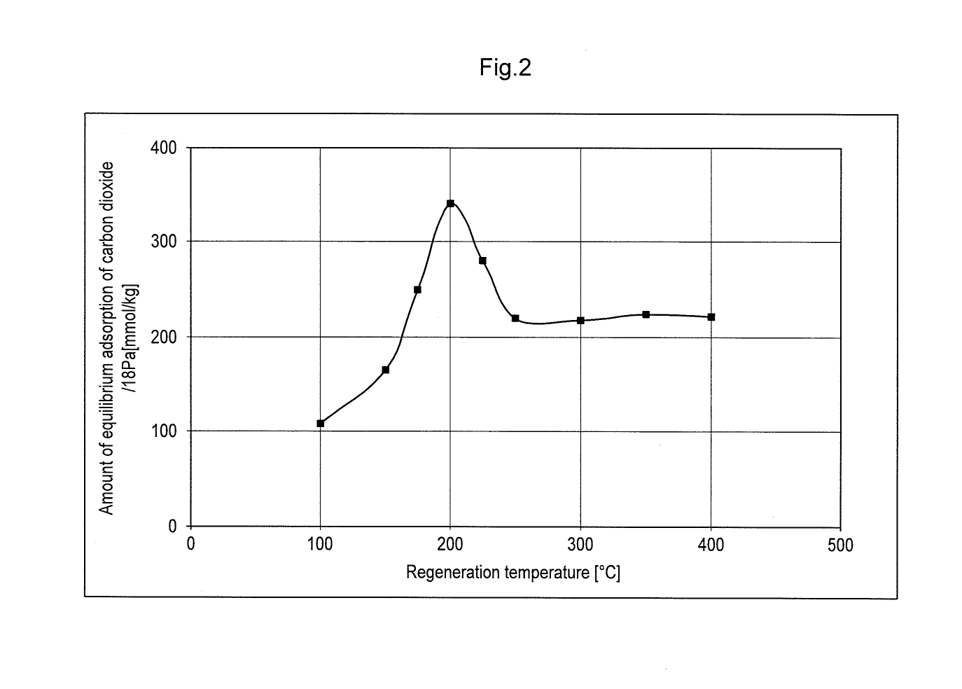

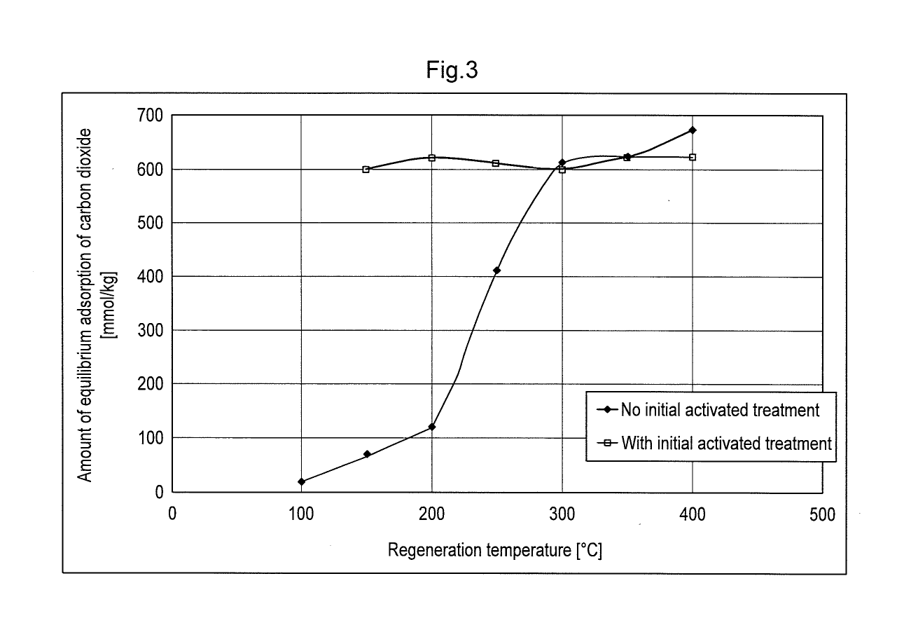

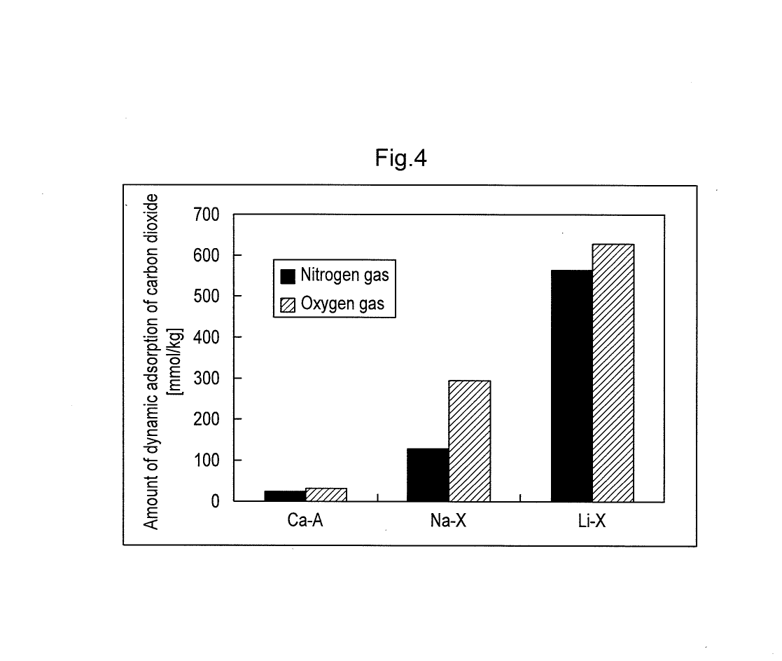

FIG. 1 is a graph illustrating a carbon dioxide adsorption isotherm of a faujasite type zeolite whose cation is sodium. The measurement of carbon dioxide adsorption was performed at a constant temperature of 25° C. by using a volumetric adsorption measuring apparatus. The faujasite type zeolite whose cation is sodium was exposed to the air before measurement and then heated while vacuuming by a vacuum pump to be regenerated. As illustrated by adsorption isotherm for each heat-regeneration temperature in FIG. 1, in the region where the partial pressure of carbon dioxide was 35 Pa or lower, the adsorption was the largest in the case where regeneration was performed at 200° C. In the relationship between the carbon dioxide adsorption and the regeneration temperature of the faujasite type zeolite whose cation is sodium illustrated in FIG. 1 at a carbon dioxide pressure of 18 Pa, as illustrated in FIG. 2, it is found that there exists a maximum point when regeneration was performed at 200° C. and in the range of a regeneration temperature of from 160° C. to 240° C., the carbon dioxide adsorption is high.

Accordingly, in the case of carbon dioxide at a partial pressure of 35 Pa or lower, by using a faujasite type zeolite whose cation is sodium as an adsorbent and by setting the regeneration temperature to from 160° C. to 240° C., adsorptive removal of carbon dioxide can be effectively performed and the amount of adsorbent can be made small, whereby the adsorption column can be miniaturized.

### Example 2

“No initial activated treatment” illustrated in FIG. 3 is a graph illustrating the relationship between the carbon dioxide adsorption and the regeneration temperature of a faujasite type zeolite whose cation is lithium. By using a volumetric adsorption measuring apparatus and by setting the temperature to 25° C. and the equilibrium partial pressure to 18 Pa, the measurement of carbon dioxide adsorption was performed. The regeneration was performed by external heating under vacuum. The carbon dioxide adsorption is found to be at its maximum when the regeneration temperature is 300° C. or higher.

The regeneration temperature dependency of the carbon dioxide adsorption (equilibrium pressure 18 Pa) of the faujasite type zeolite whose cation is lithium which was once subjected to an initial activated treatment at 300° C. is indicated by “With initial activated treatment” in FIG. 3. By this, the faujasite type zeolite whose cation is lithium which was subjected to an initial activation was found to maintain a sufficient carbon dioxide adsorption even at a regeneration temperature of 240° C. or lower.

Accordingly, the faujasite type zeolite whose cation is lithium which was subjected to an initial activation at 300° C. or higher can adsorptively remove carbon dioxide effectively even when the regeneration temperature is 240° C. or lower, and the amount of adsorbent can be made small, whereby the adsorption column can be miniaturized.

### Example 3

A faujasite type zeolite whose cation is lithium dramatically reduces its ability to adsorb carbon dioxide once it adsorbs water. Then, the faujasite type zeolite whose cation is sodium and a faujasite type zeolite whose cation is lithium were combined to purify a gas to be purified containing carbon dioxide and water as impurities. First, the gas is brought into contact with an adsorbent composed of the faujasite type zeolite whose cation is sodium to adsorptively remove water in the gas to be purified to the content thereof of 1 ppb or less, as well as, a part of carbon dioxide is adsorptively removed at a site where water is not adsorbed. Thereafter, at the downstream side, the gas is brought into contact with adsorbent composed of the faujasite type zeolite whose cation is lithium which has been subjected to an initial activation at 300° C. to adsorptively remove the residual carbon dioxide.

In this case, since the faujasite type zeolite whose cation is lithium has been subjected to an initial activation, by setting the regeneration temperature to from 160° C. to 240° C., carbon dioxide and water can be adsorptively removed effectively without compromising both properties of the sodium-type zeolite and the lithium-type zeolite.

### Example 4

In addition, although the description has been made based on the purification of oxygen gas, in order to demonstrate that the adsorption efficiency of carbon dioxide of the faujasite type zeolite whose cation is sodium or lithium is high also in nitrogen gas, the amount of dynamic adsorption of carbon dioxide in oxygen gas and nitrogen gas were measured by a dynamic adsorption measuring apparatus for faujasite type zeolite whose cation is sodium, faujasite type zeolite whose cation is lithium and molecular sieve 5A generally used for purification.

The amount of dynamic adsorption is measured by flowing a gas containing impurities in an adsorption column filled with adsorbent. A means for detecting impurities at the outlet of the adsorption column is provided and the time until the breakthrough is measured. The amount of dynamic adsorption is indicated by a value obtained by dividing the amount of impurities introduced into the adsorption column at that time by the amount of adsorbent which is filled in the adsorption column.

The effect of the adsorption rate is taken into account in the amount of dynamic adsorption, which is one of other performance indexes of the adsorbent than the amount of equilibrium adsorption.

Each stainless column measuring 23.9 mm in inner diameter is filled with the adsorbent in height of 500 mm for nitrogen gas and in height of 400 m for oxygen gas to obtain each adsorption column.

In the case where the faujasite type zeolite whose cation is sodium and molecular sieve 5A were used as adsorbents, the regeneration was performed by heating at 200° C. while flowing nitrogen gas and oxygen gas. In the case where the faujasite type zeolite whose cation is lithium was used as an adsorbent, the initial activation was performed by heating at 300° C. while allowing to flow nitrogen gas and oxygen gas.

After the regeneration or after the initial activation, nitrogen gas and oxygen gas to each of which 30 ppm of carbon dioxide was added were allowed to flow at a temperature of 25° C., at a pressure of 500 kPaG and at 12 NL/min to measure change in the concentration of carbon dioxide in a gas at the outlet of the adsorption column by a hydrogen flame ionization detector-type gas chromatograph with a methanizer.

The partial pressure of carbon dioxide at 30 ppm contained in a gas at a pressure of 500 kPaG is 18 Pa.

The point where the concentration of carbon dioxide in the outlet gas exceeds 10 ppb is defined as a breakthrough time. The amount of dynamic adsorption of carbon dioxide calculated from the breakthrough time for each adsorbent is illustrated in FIG. 4. In FIG. 4, a faujasite type zeolite whose cation is sodium is denoted by Na-X, a faujasite type zeolite whose cation is lithium is denoted by Li-X and a molecular sieve 5A is denoted by Ca-A, respectively.

From FIG. 4, it was confirmed that the faujasite type zeolite whose cation is sodium or lithium had a very large amount of dynamic adsorption of carbon dioxide at a low partial pressure as compared to that of a conventional molecular sieve 5A.

As mentioned above, although a conventional molecular sieve 5A has been preferably used for removing carbon dioxide in a purification apparatus, since the carbon dioxide adsorption at a partial pressure of 35 Pa or lower is small, the adsorption column of the purification apparatus becomes large, which has been problematic. When a faujasite type zeolite whose cation is sodium or lithium is used for a carbon dioxide adsorbent of the purification apparatus, the adsorption column of the purification apparatus can be dramatically miniaturized, and the cost can be reduced and the amount of regeneration gas can be reduced, whereby the running cost can be reduced.

Although the gas purification method of the present embodiment is described based on a twin-column type TSA apparatus, the method can also be applied to a TSA apparatus provided with two or more adsorption columns. The method is not limited to the purification of oxygen gas or nitrogen gas and can also be applied to the cases when purifying other gases containing carbon dioxide and/or water as impurities, for example, an inert gas such as He, Ne or Ar; a rare gas such as Kr or Xe; a combustible gas such as H₂, CO, methane, propane; or chlorofluorocarbon such as CF₄.

1. A gas purification method in which a gas to be purified which contains carbon dioxide having a partial pressure of 35 Pa or lower as impurities is brought into contact with an adsorbent whose heat-regeneration temperature is set to from 160° C. to 240° C. composed of a faujasite type zeolite whose cation is sodium to adsorptively remove the carbon dioxide.

2. The gas purification method according to claim 1, wherein the faujasite type zeolite whose cation is sodium is exposed to the air or a gas containing water, and then is subjected to heat-regeneration to adsorptively remove the carbon dioxide.

3. A gas purification method in which a gas to be purified which contains carbon dioxide as an impurity is brought into contact with an adsorbent composed of a faujasite type zeolite whose cation is lithium to adsorptively remove the carbon dioxide, characterized in that the faujasite type zeolite whose cation is lithium is subjected to an initial activation at 300° C. or higher, and subjected to heat-regeneration at 240° C. or lower in a subsequent regeneration process to adsorptively remove carbon dioxide repeatedly.

4. A purification method in which: a gas to be purified which contains carbon dioxide and water as impurities is brought into contact with an adsorbent composed of a faujasite type zeolite whose cation is sodium to adsorptively remove a part of carbon dioxide and water; and
in the downstream thereof, the gas is brought into contact with an adsorbent which is subjected to an initial activation at 300° C. or higher and composed of a faujasite type zeolite whose cation is lithium to adsorptively remove the residual carbon dioxide, wherein the regeneration temperature of both adsorbents is from 160° C. to 240° C.

5. The gas purification method according to claim 4, wherein water in a gas to be purified is adsorptively removed to the content thereof of 1 ppb or lower by the adsorbent composed of a faujasite type zeolite whose cation is sodium, as well as, a part of carbon dioxide is adsorptively removed at a site where water is not adsorbed.
